(19) United States
(12) Patent Application Publication
(10) Pub. No.: US 2015/0276245 A1
(43) Pub. Date: Oct. 1, 2015

(54) FLOW ACTUATED FLAP VALVE

(71) Applicant: CAMFIL USA, INC., Riverdale, NJ (US)

(72) Inventors: Michael C. WALTERS, Jonesboro, AR (US); Ulf PERSSON, Helsingborg (SE); Dominick BISOGNI, Jonesboro, AR (US)

(73) Assignee: CAMFIL USA, INC., Riverdale, NJ (US)

(21) Appl. No.: 14/242,569

(22) Filed: Apr. 1, 2014

(51) Int. Cl. F24F 7/08; B01D 46/42; B01D 46/00; B01D 46/48; F24F 13/14; F24F 13/28

(52) U.S. Cl. CPC F24F 7/08; F24F 13/1486; F24F 13/28; B01D 46/0019; B01D 46/48; B01D 46/4272; B01D 46/4227

(57) ABSTRACT

The present invention generally relates to a backdraft damper having a flap valve, a dust collector having a backdraft damper and a method for preventing a pressure wave from propagating upstream of a dust collector. In one embodiment, a backdraft damper is provided that includes a body having a flap valve disposed therein. The flap valve includes a valve seat disposed in an interior volume of the body. The flap valve includes a blade movable between an open position and a closed position which prevents fluid flow between an inlet and an outlet of the body. The blade of the flap valve includes a core material sandwiched between a first plate and a second plate.

### BACKGROUND

1. Field

The present invention relates to an isolation value and in particular, a passive flow activated flap valve for use in an explosive environment.

2. Description of the Related Art

Almost every piece of process equipment in a powder and bulk solid handling plant depends on an engineered air handling system to safely control dust or to reclaim valuable product. The air handling system may include a dust collector to remove small particles from the air in the process environment which may lead to manufacturing defects or present health and safety concerns to the operators. A fan is typically coupled to the dust collector to pull particulate-laden air through a dirty air plenum and through the air filters of the dust collector in order to remove small particles suspended in the process air. In a recirculating dust collection system, the clean air is returned to the process environment through a clean air plenum after moving through the air filters. The small particles filtered from the process air are collected at the dust collector for removal.

The size and quantity of the particles in the process environment air is largely dependent on the operations performed therein. Any combustible material can burn rapidly when the material is in a finely divided form. If such a dust is suspended in air in the right concentration, under certain conditions, it can deflagrate. Even materials that do not burn in larger pieces (such as aluminum or iron), given the proper conditions, can become explosive in a dust form. A wide variety of materials that can be explosive in dust form exist in many industries. For example: sugar, feed, wood, paper, pesticides, pharmaceuticals, coal, and metals to name a few.

The dust collection system can produce optimum conditions for dust explosions. Ignition sources such as embers or sparks can be produced by process machinery and then transported by the dust collection system to an optimum airborne dust concentration for a dust explosion. A dust explosion in the dust collection system can travel back via the dirty air plenum and damage connected plant equipment and plant personnel. Such an explosion if allowed to travel back to the process environment may be catastrophic and even life threatening. The force from such an explosion can cause employee deaths, injuries, and even destroy entire buildings. For example, 3 workers were killed in a 2010 titanium dust explosion in West Virginia, and 14 workers were killed in a 2008 sugar dust explosion in Georgia. For this reason, dust collection systems use certified explosion vents and backdraft dampers to prevent the deflagration of dust from propagating back to the process environment.

Conventional backdraft dampers use a flap valve to isolate the process environment from the deflagrating material (or explosion). Typically at the moment of detection, an explosion pressure is about 35 to 100 mbar (0.035 bar to 0.100 bar) when the flap valve of the backdraft damper is activated. The risk of damage to the flap valve due to the rapidly increased pressure of the explosion makes necessary the replacement of the flap valve to ensure future safe operation of the backdraft damper.

Conventional backdraft dampers use a single thickness of sheet metal for the blade of the flap valve. The blade is strengthened with bar and angle stiffeners on the backside, or downdraft side, of the blade. These stiffeners provide a place for dust to build up which adds mass to the blade. The added weight to the blade requires additional static pressure in the air flow to keep the blade in an open position. Thus, the dust build-up on the stiffeners changes the dynamics of the blade, i.e., mass which could cause damper to fail when closed by a deflagration. Additionally, the dust build-up on the stiffeners adds fuel for the propagating flame front to ignite.

Replacing and maintaining the flap valve, such as for cleaning and dust removal, requires taking the dust collection system offline. However, taking the dust collection system offline often requires that the connected process equipment must also be taken offline, resulting in downtime much more costly than just the cost of the flap valve itself.

Thus, there is a need for an improved flap valve.

### SUMMARY

The present invention generally relates to a backdraft damper having a flap valve, a dust collector having a backdraft damper and a method of preventing a pressure wave from propagating upstream of a dust collector. In one embodiment, a backdraft damper is provided that includes a body having a flap valve disposed therein. The flap valve includes a valve seat disposed in an interior volume of the body. The flap valve includes a blade movable between an open position and a closed position which prevents fluid flow between an inlet and an outlet of the body. The blade of the flap valve includes a core material sandwiched between a first plate and a second plate.

In another embodiment, a dust collector is provided that includes a backdraft damper coupled to an inlet of a housing. The backdraft damper includes a body having a flap valve disposed therein. The flap valve includes a valve seat disposed in an interior volume of the body. The flap valve includes a blade movable between an open position and a closed position which prevents fluid flow between an inlet and an outlet of the body. The blade of the flap valve includes a core material sandwiched between a first plate and a second plate.

In yet another embodiment, a method of preventing a pressure wave from propagating upstream of a dust collector is provided that includes drawing air flow into a backdraft damper having a cored damper blade disposed in an open position, and locking the cored damper blade in a closed position in response to a pressure wave propagating in a direction opposite the drawn air flow.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a plan view of an embodiment of a dust collector.

FIG. 2 is a side elevation of a backdraft damper for the dust collector of FIG. 1.

FIG. 3 is an enlarged portion of the backdraft damper shown in FIG. 2.

FIG. 4 is a partial cut away elevation of the backdraft damper shown in FIG. 2.

FIG. 5 is a side elevation of a blade for the backdraft damper shown in FIG. 4.

FIG. 6 is an enlarged portion of a locking mechanism for the backdraft damper shown in FIG. 2.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

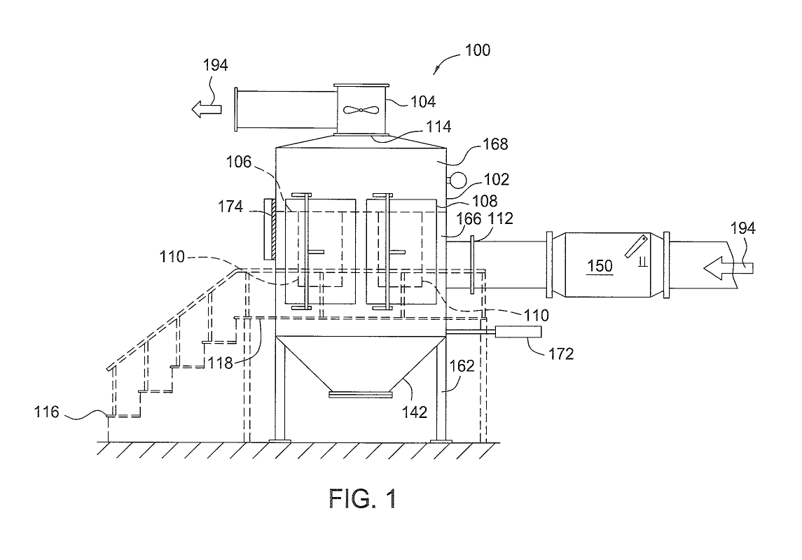

FIG. 1 is a plan view of one embodiment of a dust collector 100. The dust collector 100 includes a housing 102, and an optional air mover or fan 104. The housing 102 of the dust collector 100 holds at least one replaceable main air filter 110, shown in phantom. The housing 102 has an inlet 112 and an outlet 114. The inlet 112 is coupled to a backdraft damper 150. Although, the exemplary configuration of the dust collector 100 is shown in FIG. 1, it is contemplated that other configurations of dust collectors may be adapted to benefit from the embodiments described herein, including dust collectors of varying designs available from different manufactures.

The housing 102 is constructed from a rigid material suitable to withstand the operational pressures and loading for which the particular dust collector is designed. The housing 102 is supported by legs 162 and additionally includes at least a main air filter access port (not shown), a main air filter access door 108, a main air filter mount 106 (shown in phantom), and a collection hopper 142. The fan 104 of the dust collector 100 creates a flow 194 which pulls air into the dust collector 100 through the inlet 112 and out of the dust collector 100 through the outlet 114.

The main air filter access port is sealable by the air filter access door 108. Steps 116 (shown in phantom) lead to a platform 118 to allow for easy access to both the filter ports and associated access doors 108. The main air filter access door 108 may be opened to respectively replace and service the main air filter disposed in the housing 102. The main air filter access door 108 may be closed to sealingly isolate the interior of the housing 102 from the surrounding environment.

A dirty air plenum 166 and a clean air plenum 168 are defined in the housing 102 and separated by the main air filter mount 106, which is sealed to the walls of the housing 102. The inlet 112 formed through the housing 102 opens to the dirty air plenum 166. A plurality of main air filter apertures are formed through the main air filter mount 106. The flow of air from the dirty air plenum 166 to the clean air plenum 168 must pass through one of the apertures of the main air filter mount 106.

The main air filter 110 is sealingly mounted, for example clamped, to the main air filter mount 106 over each aperture. Thus, air passing through the aperture formed through the main air filter mount 106 from the dirty air plenum 166 to the clean air plenum 168 must also pass through the main air filter 110. The main air filter 110 may be a canister filter, bag filter or other suitable filter. The main air filter 110 may be configured to have a filtering efficiency in the range of about 99.99% to about 99.999% at 0.5 micron and larger particles by weight, or other suitable efficiency. Exemplary filters suitable for use as the main air filter 110 are available from Air Pollution Control (APC) a division of Camfil USA Inc., located in Jonesboro, Ark., among other manufactures.

The inlet 112 of the dust collector 100 is coupled to a processing environment typically by ductwork. The processing environment may contain machines or materials which generate fine particulates, debris, or other small particles capable of suspension in air, such as dust. The air from the process environment may be moved in the direction of the flow 194 by the fan 104 through the inlet 112 of the dust collector 100 for filtering.

The dust collector 100 may be National Fire Protection Association (NFPA) compliant for the collection of a combustible dust/material. The dust collector 100 may incorporate one or more devices to protect from an explosion or the deflagration of the combustible dust. For example, the housing 102 of the dust collector 100 may have an explosion or flameless vent 174. The vent 174, when configured as an explosion vent, may be designed as a weak link in the housing 102 configured to fail in an explosion in order to minimize damage to the dust collector 100 caused by overpressure from an explosion or defragmentation event within the dust collector 100. The vent 174, when configured as a flameless vent, may install over the explosion vent and extinguish the flame front exiting the vent 174. In another example, the housing 102 may additionally have a chemical suppression system 172 installed on the dirty air section of the dust collector 100. The chemical suppression system 172 may react upon detecting an explosion to inject an agent into the housing 102 that chemically suppress the flames associated with the explosion.

The backdraft damper 150 may be coupled to the inlet 112 of the dust collector 100 to protect the process environment. The backdraft damper 150 may be NFPA compliant. The backdraft damper 150 is configured to allow air to pass through in only the direction of the flow 194, i.e., from the processing environment into the dirty air plenum of the dust collector 100. For example, the backdraft damper 150 may be a type of check valve. The backdraft damper 150 thus prevents air, or other materials, from traveling back through the inlet into the processing environment. During an explosion, or other deflagration event, air expands in all directions and the air may travel in a direction opposite the flow 194. Deflagration is a rapid high energy combustion event that propagates through a gas or an explosive material at subsonic speeds, driven by the transfer of heat. The backdraft damper 150 prevents the heat, or flames, associated with the deflagration event from propagating down the inlet 112 in a direction opposite the flow 194 and into the process environment.

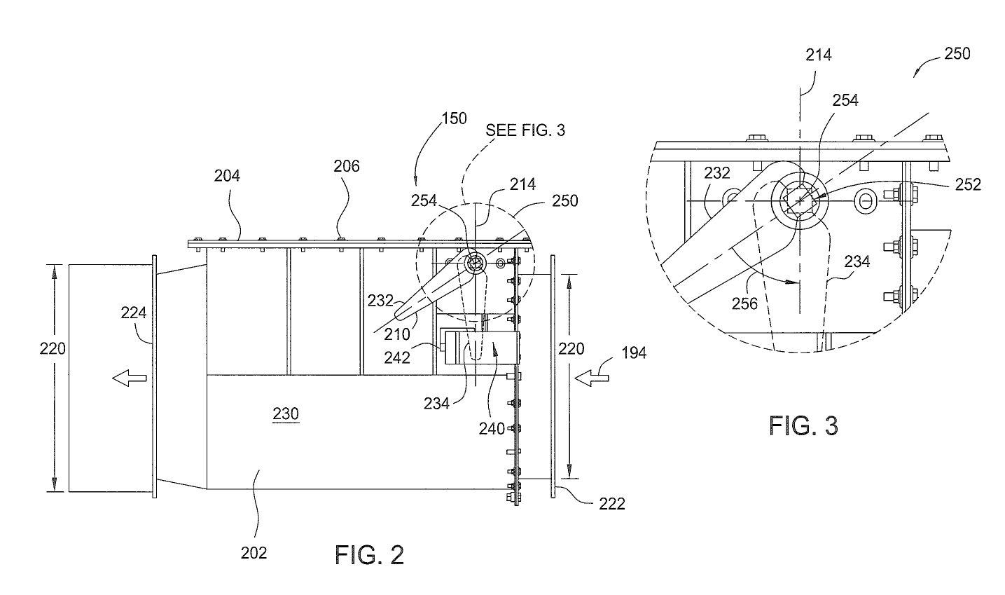

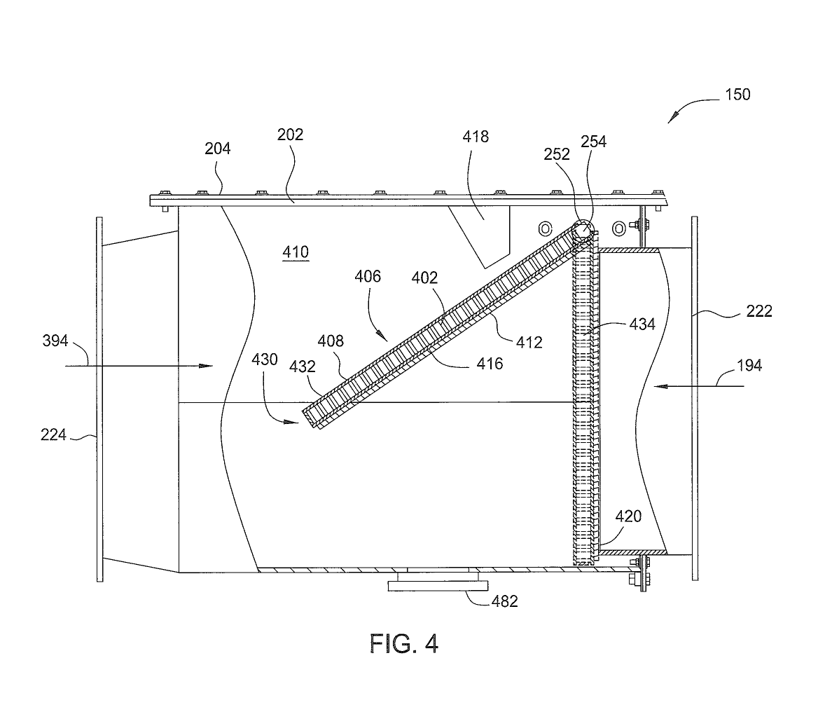

FIG. 2 is a side elevation of the backdraft damper 150 for the dust collector 100 of FIG. 1. The backdraft damper 150 has a body 202 and a top 204. The body 202 has an exterior surface 230. The top 204 may be secured by fasteners 206, such as bolts, screws or other suitable connectors, to the body 202. In one embodiment, the top 204 may be removable to allow access to an interior volume 410 of the body 202, as shown in FIG. 4.

The body 202 has an inlet 222 and an outlet 224. The inlet 222 and the outlet 224 may have a diameter 220 sized to interface with the inlet 112 of the dust collector 100 shown in FIG. 1. The diameter 200 of the inlet 112 and the diameter 220 of the outlet 224 may be about 6 inches or more, such as about 24 inches and up to about 40 inches. The inlet 112, and the diameter 220, may be sized according to a desired cubic foot of flow for the dust collector 100. The backdraft damper 150 is configured such that the flow 194 generated by the dust collector 100 enters the inlet 222 from the processing environment and exits the outlet 224 of the backdraft damper 150 into the inlet 112 of the dust collector 100.

A handle 210 may be deposed on the exterior surface 230. The handle 210 may pivot about an axis of rotation 254. The handle 210 may rotate between an open position 232 and a closed position 234, as shown by arrow 256 depicted in FIG. 3. The position of the handle 210 may indicate whether the backdraft damper 150 is in an open position wherein the flow 194 may enter the inlet 222 and exit the outlet 224. For example, the handle 210 may be oriented in a predetermined position which may indicate the backdraft damper 150 is in an open position. The handle 210 may be formed from a resilient material which provides a spring force when deformed. For example, the handle 210 may be formed from an aluminum or steel plate which is able to deflect in the direction perpendicular to the direction of rotation as shown by arrow 256. So that the end of the handle 210 is biased against a locking mechanism 240 when the handle 210 is in the closed position 234.

Turning to FIG. 3, an enlarged portion 250 of the backdraft damper 150 is shown. The portion 250 of the backdraft damper 150 depicts a section of the handle 210 near the axis of rotation 254 of the handle 210. The handle 210 may be configured to accept a square shaft 252. The handle 210 may have a square hole milled or formed therein, thus providing strong mating and coupling of the square shaft 252 and the handle 210 which substantially prevents rotation therebetween. The square shaft 252 extends through an opening formed in the body 202 and is coupled to a blade (illustrated as blade 430 in FIG. 4) of the damper 150, as further discussed below. The square shaft 252 has a geometric center which may serve as the axis of rotation 254 for the handle 210 and the blade. Rotating the handle 210 between the open position 232 and the closed position 234 brings about a corresponding rotation of the square shaft 252. Thus, as the square shaft 252 rotates about the axis of rotation 254 as the blade moves between the open and closed positions, so does the handle 210.

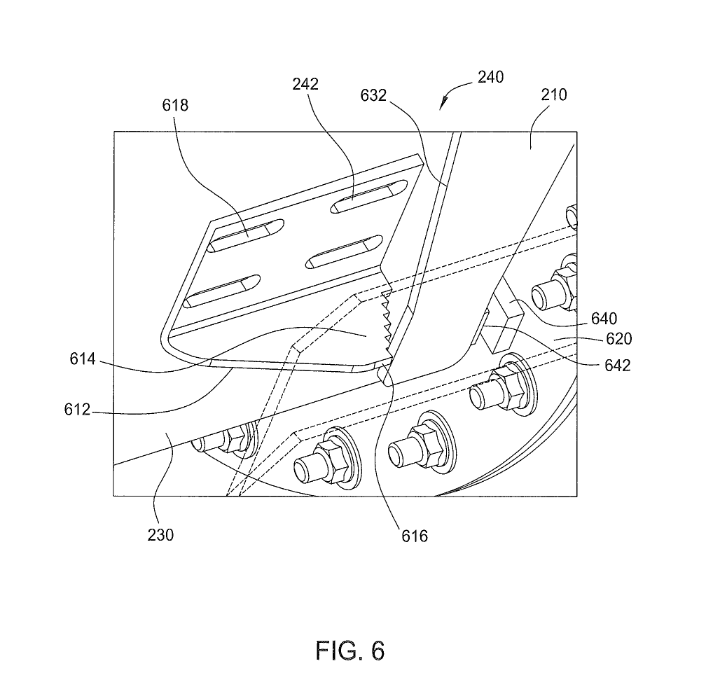

Returning to FIG. 2, the locking mechanism 240 may be deposed on the exterior surface 230 of the body 202. The locking mechanism 240 may have a latch 242. The latch 242 may be a spring latch, slam latch, cam lock. Norfolk latch, step ladder latch (as shown in FIG. 6) or other suitable latching mechanism. The latch 242 may be configured to allow the movement of the handle 210 into the closed position 234 from the open position 232. Additionally, the latch 242 may automatically prevent the movement of the handle 210 into the open position 232 from the closed position 234 without some sort of intervention, manual or otherwise. Thus, when the handle 210 moves into the closed position 234, the handle 210 being biased against the latch 242, may automatically engage the latch 242 and lock the handle 210 in the closed position 234, thereby securing the blade in a closed position, thereby preventing flow towards the process environment. Unlocking the handle 210 may involve manually releasing the latch 242 to allow the handle 210 to move from the closed position 234 to the open position 232.

In one embodiment shown in FIG. 6, the locking mechanism 240 is a self adjusting so that the handle 210, and thus the blade 430, is held in the closed position independent of any change in the angular orientation of the shaft 252. For example, if the angle between the blade 430 and the shaft 252, when the blade 430 is in the closed position, changes over time due to deflecting, deformation, slippage, or other factor, the latch 242 automatically compensates for the change while still securing the handle 210 in the position that holds the blade 430 in the closed position.

The latch 242 may have a body 618. The body 618 of the latch may be mounted to the exterior surface 230 of the backdraft damper 150. The body 618 may have an angular leading edge 612 and a stepped edge 614 opposite the leading edge 612. The body 618 may additionally have a side 616 disposed between the stepped edge 614 and the leading edge 612. A kickback guard 620 may rest against the side 616 of the latch 242.

During a deflagration event, the handle 210 may be caused to rotate in a direction which places the handle 210 into contact with the leading edge 612 of the latch 242. The angle of the leading edge 612 of the latch 242 deflects the handle 210 toward the kickback guard 620 and around the side 616 of the latch 242, creating a spring bias which urges the handle against the latch 242. A trailing edge 632 of the handle 210 is biased against and engages the stepped edge 614, thereby preventing the handle 210 from rotating back to allow the handle 210, and thus the blade 430, to move into an open position. The handle 210 may be adjusted to increase the force required for locking the handle in the latch 242. The deflagration event may cause damage to the backdraft damper 150 and cause the handle 210 to rotate past a normal closed position. Advantageously, the plurality of steps comprising the stepped edge 614 allows the handle to continue to rotate past the closed position should a deflagration event deform or damage the backdraft damper 150 while still engaging at least one of the steps. Thus, the stepped edge 614 of the latch 242 prevents the handle 210 from rotating in the opposite direction and keep flames or other fluids from flowing through the backdraft damper 150 into the process environment.

A sensor 614 may determine when the latch 242 has been activated. The sensor 614 may detect the location of the handle 210, force on the latch 242 by the handle 210, or provide some other means for determining the latch 242 has been activated. The sensor 640 may be placed proximate the handle 210, for example proximate the stepped edge 614. The sensor 614 may be a magnetic sensor, proximity sensor, strain gage, optical sensor, reed switch, mechanical switch or other suitable sensor for determining when the handle 210 has engaged the latch 242. The handle 210 may have a plate 642 which is detectable by the sensor. The plate 642 may be a magnet, reflective target, or other suitable material/device which is recognizable by the sensor 640. The sensor may be configure to shut the dust collector 100 down upon the sensor 640 observing the plate 642 or handle 210 in passing through a predetermined position. The handle 210 may be configure to not engage the latch 242 during normal shutdown of the dust collector 100 and thus not place the plate 642 or handle 210 in a position which may activate the sensor 640 and prohibit the startup of the dust collector 100.

In one embodiment, a fluid flow, having a pressure wave greater than that of the flow 194, traverses through the interior volume 410 of the backdraft damper 150 in a direction from the outlet 224 to the inlet 222. The pressure wave interacts with the blade of the backdraft damper 150 and causes the handle 210 to rotate about the axis of rotation 254 and engage the locking mechanism 240.

FIG. 4 is a partial cut away elevation showing the interior volume 410 of the backdraft damper 150 depicted in FIG. 2. The interior volume 410 has a flap valve 406 deposed therein. The flap valve 406 has a blade 430 and a valve seat 420. The blade 430 is attached to the square shaft 252 and rotates about the axis of rotation 254, as discussed above. The blade 430 may rotate between an open position 432 and a closed position 434. The blade 430 may rotate upward in the direction of the open position 432 until contacting a support stop 418 which prevents the blade 430 from rotating further in the open direction. The blade 430 in the open position 432 permits fluids, such as air, to flow through the flap valve 406 in a direction of flow 194, i.e., in through the inlet 222 and out through the outlet 224. Generally, the blade 430 is passively operated (i.e., no actuators) such that the rate of air flow 194 through the body 202 is sufficient to hold the blade 430 in the open position. The blade 430 may rotate downward into the closed position 434 until contacting the valve seat 420 in response to a pressure wave propagating in the direction of the flow 194. The blade 430 in the closed position 434 prevents fluids, such as air, from flowing through the flap valve 406 in a direction opposite the direction of the flow 194. For example, the blade 430 in the closed position 434 may prevent air from flowing in through the outlet 224 and out through the inlet 222 toward the process environment.

The blade 430 has a hollow core construction. For instance, the blade 430 may consist of a core 402, such as a honeycomb core, sandwiched between a first (or backside) plate 408 and a second (or frontside) plate 416. The backside plate 408 and the frontside plate 416 may be formed of a similar material, such as a metal. For example, the plates 408, 416 may be fabricated from steel or aluminum (Al). Alternately, the backside plate 408 and the frontside plate 416 may be formed from different materials. For example, the backside plate 408 may be formed from a material more resistant to heat than the frontside plate 416. In one embodiment, the core 402 is fabricated from a lightweight aluminum honeycomb material. This creates a strong blade that does not require stiffeners to be placed on the exterior surface of the backside plate 408. Thus, the side of the blade 430 (backside plate 408) facing outlet 224 is smooth without protruding elements. Therefore, dust does not collect on the exterior surface of the blade 430 (backside plate 408) which faces the outlet 224, which may add weight to the blade 430 or fuel to a deflagration event. Advantageously, the lighter blade 430, as compared to conventional blades reduces energy consumption since less flow is needed to hold the blade 430 in the open position.

The hollow core construction of the blade 430 also provides a secure mount for the square shaft 252 on which the blade 430 pivots. For example, the core 402 may abut one side of the square shaft 252 and have a thickness similar to the thickness of the square shaft 252. The backside plate 408 and the frontside plate 416 may overlap the adjacent sides of the square shaft 252 and thus incorporate the square shaft 252 into the laminate of the blade 430. The square shaft 252 also allows easy replacement of the blade 430 when needed. The square shaft 252 also provides for secure installation of the locking collar and the handle 210 (as shown in FIG. 2). The square shaft 252 prevents the collar and handle 210 from slipping by providing solid flat mating surfaces between the square shaft and the collar and the handle 210. Thus, when the flap valve 406 is closed by a deflagration event, i.e., an explosion, neither the blade 430 nor the handle 210 slip on the square shaft 252 even when the handle is in the locked position.

Heavy blades used in conventional backdraft dampers close slower and may cause damage to the valve housing. The heavy blades used in conventional backdraft dampers also consume more energy. To mitigate the problems found in the conventional blades, the blade 430 of the backdraft damper 150 uses a hollow core construction which provides increased strength while maintaining light weight. The hollow core construction of the blade 430 enables the blade 430 to close very quickly without damaging either the blade 430 or the flap valve 406 during a deflagration event.

The blade 430 of the flap valve 406 is in the air stream on the dirty side of the dust collector 100. The flow 194 exerts a force on the frontside plate 416 of the blade 430 causing the blade to rotate about the axis of rotation 254 until the backside plate 408 of the blade 430 comes into contact with the support stop 418. Thus, the frontside plate 416 of the blade 430 is subject to wear from the suspended particles present in the flow 194. Since the hollow core construction for the blade 430 is very light for its strength, a non-structural wear liner 412 may be disposed on the frontside plate 416 of the blade 430 to mitigate wear from particles suspending in the air flow 194 without making the blade 430 undesirably heavy. The weight of this liner 412 may be small and does not affect the performance of the blade 430. The liner 412 is a non-structural element, and as such, the blade 430 does not derive any strength from the liner 412, and so as the liner 412 wears, the blade 430 will maintain its design performance strength. Thus, erosion over time to the liner 412 of the blade 430 does not affect the strength of the blade 430. The erosion to the liner 412 may also indicate when the blade 430 should be replaced. For example, exposure of the backside plate 408 behind the liner 412 (either through holes in the liner 412 or by the liner 412 becoming translucent) will indicate the need to replace the blade 430. The thickness of the liner 412 may also be monitored with a sensor or optional view window 482 formed in the body 202 of the backdraft damper 150. The thickness of the liner may provide an indication of when the blade 430 needs replacing. Thus, the amount of wear on the blade 430 may be monitored without removing the blade 430 or taking the dust collector 100 offline.

As discussed above, the flap valve 406 is configured to allow the blade 430 to close 434 when a deflagration event occurs in the dust collector 100. The flap valve 406 may be a passive flow actuated flap valve in compliance with NFPA standards for explosions and/or deflagration events within the dust collector 100. The flap valve 406 operates similar to a check valve for preventing the reverse flow into the processing environment of air associated with a deflagration event. When a deflagration or explosion occurs in the dust collector 100, the flap valve 406 substantially prevents the flame and pressure wave from propagating upstream and reaching the process environment. Since the pressure wave travels faster than the flame front, the pressure wave contacts the backside plate 408 of the blade 430 causing the blade 430 to rotate into the closed position 434 and seal against the valve seat 420 to prevent the flame front from escaping the backdraft damper 150. The closing of the blade 430 causes the square shaft 252 fixed to the blade 430 to rotate as well. As discussed with reference to FIG. 2, the rotation of the square shaft 252 causes the handle 210, attached thereto, to engage the locking mechanism 240 and therefore lock the blade 430 into the closed position 434.

At the moment an explosion is detected in the dust collector 100, the explosion pressure may be about 35 to about 100 mbar. The cored design of the blade 430 for the backdraft damper 150 has demonstrated to withstand up to at least a St 1 class dust explosion and up to a St 2 class dust explosion as described in OSHA CPL 03-00-008—Combustible Dust National Emphasis Program (NEP) and the National Fire Protection Association (NFPA) 68 standard on explosion prevention by deflagration venting. The dust explosion classes are defined as follows:

TABLE 1

| Dust Explosion Class | Kₛₜ (bar m/s) | Characterization |
|---|---|---|
| St 0 | 0 | Non-explosive |
| St 1 | 0 < Kₛₜ < 200 | Weak to moderately explosive |
| St 2 | 200 < Kₛₜ < 300 | Strongly explosive |
| St 3 | Kₛₜ > 300 | Very strongly explosive |

The Kₛₜ value represents the maximum rate of pressure rise

$$( dp / dt )$$

during a dust explosion event in an equi-dimensional vessel, multiplied by the cube root of the vessel volume Vᵥₑₛₛₑₗ. In other words:

$${K}_{st} = {( dP / dt )}_{max} \times \sqrt[3]{{V}_{vessel}}$$

The blade 430, for the backdraft damper 150, is configured to block fluid flowing from the outlet at a pressure of at least between about between about 0.035 bar and about 0.10 bar or more.

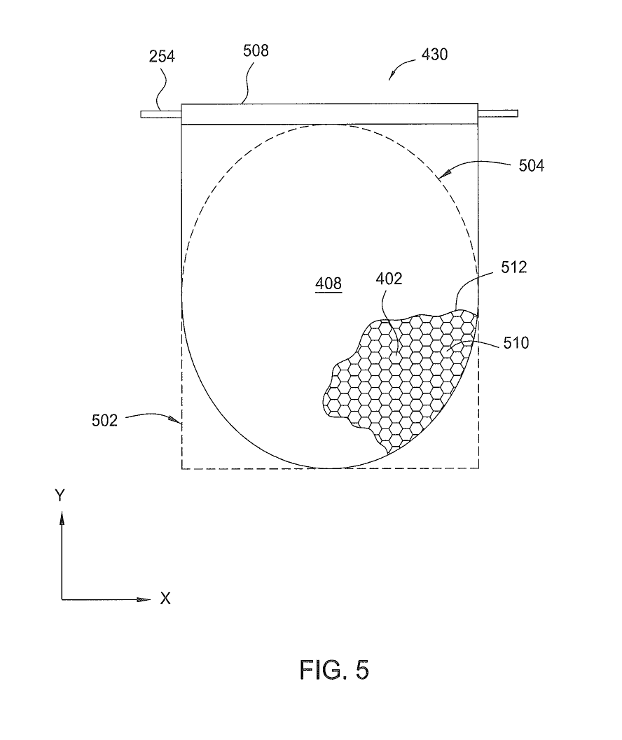

FIG. 5 is a side elevation of the blade 430 for the backdraft damper 150 of FIG. 4. The blade 430 is removed from the flap valve 406 and oriented to show the backside plate 408. The square shaft 252 extends from a top surface 508 of the blade 430. The blade 430 is configured to fit the inlet 222 of the backdraft damper 150 and may be sized according to air flow 194 requirements. The shape of the blade 430 may be oval (shown by dashed line 504), circular, rectangular (shown by dashed line 502) or any other shape suitable for closing the flap valve 406.

In FIG. 5, a portion of the core 402 in the blade 430 is exposed. A cutaway 512 of the backside plate 408 exposes the core 402 having a hexagonal honeycomb 510. The hexagonal honeycomb 510 having walls disposed perpendicular to the plane of the backside plate 408. The hexagonal honeycomb 510 adds strength to the backside plate 408 and the frontside plate 416 while minimizing the overall weight of the blade 430. Alternately, the core 402 may be square, circular, sandwich panel, foam (open or closed cell), reinforced hexagonal, cross core or other suitable lightweight structural material.

The backside plate 408 and the frontside plate 416 may be secured to the core 402, for example, using fasteners, welds or adhesives. Suitable adhesives include a polymer film, a polyurethane resin, an epoxy resin, or other suitable adhesive with a strong peel strength that are able to withstand a deflagration event. In one embodiment, the adhesive is a polymer film with slits heated under pressure which laminates the backside plate 408 and the frontside plate 416 to the core 402.

In one embodiment, the backside plate 408 and the frontside plate 416 of the blade 430 is formed from aluminum (Al) plate, while the core 402 is formed from a honeycomb material, such as an aluminum hexagonal honeycomb material. This construction allows the blade 430 and the backdraft damper 150 to withstand a dust explosion pressure wave of at least about 0.09 Bar.

Advantageously, utilizing the composite blade in the backdraft damper improves the backdraft damper by eliminating dust build up on the back of the blade while increasing the strength to weight ratio of the blade. The elimination of dust build up on the back of the blade helps to maintain a low pressure drop across the valve which in turn saves energy. The eliminated dust holding features on the exterior of the blade also removes potential fuel which may contribute to a deflagration event. Additionally, the eliminated build-up of dust also helps maintain low blade weight and the operation dynamics of the backdraft damper. The cored construction produces a blade that is strong and light weight, which enables the addition of an optional wear protection liner that does not contribute significantly to the weight of the blade, and may serve as a wear indicator. The blade may be mounted on a square shaft that can easily be replaced. The blade may be coupled to a latching arm that is securely attached to the square shaft that will not slip when activated by a deflagration event. Thus, the cored blade reduces operation costs while providing NFPA compliant safety measures for reducing harm to personnel and equipment from deflagration events, or dust explosions in a dust collector.

While the foregoing is directed to embodiments of the present disclosure, other and further embodiments of the disclosure may be devised without departing from the basic scope thereof, and the scope thereof is determined by the claims that follow.

What is claimed is:

1. A backdraft damper comprising:
a body having an interior volume with an inlet and an outlet configured to allow a fluid to flow therethrough; and
a flap valve having a valve seat disposed in the interior volume, the flap valve comprises:
a blade disposed in the interior volume and movable between an open position and a closed position which prevents fluid flow between the inlet and outlet of the body during a deflagration of a combustible dust having a Kₛₜ of about 200 or less, wherein the blade does not have external stiffeners and the blade comprises:
a first plate;
a second plate; and
a core material sandwiched between the first and second plates.

2. The backdraft damper of claim 1, wherein the blade is configured to prevents fluid flow between the inlet and outlet of the body during the deflagration of a combustible dust having a Kₛₜ of about 300 or less.

3. The backdraft damper of claim 1, wherein an exterior surface of the blade facing the inlet when in the closed position is without protruding elements.

4. The backdraft damper of claim 1 further comprising:
a shaft coupled to the blade and having a square profile.

5. The backdraft damper of claim 4 further comprising:
a handle attached to the square profile of the shaft; and
a latch configured to engage the handle and automatically lock movement of the blade when the blade in the closed position.

6. The backdraft damper of claim 4, wherein the square profile of the shaft is laminated between the plates.

7. The backdraft damper of claim 1, wherein the blade further comprises:
a liner disposed on the first plate.

8. The backdraft damper of claim 1, wherein the first plate and the second plate are formed from aluminum, and the core material is formed from a honeycomb material.

9. The backdraft damper of claim 1 further comprising:
a locking mechanism configured to automatically retain the blade in the closed position.

10. The backdraft damper of claim 9, wherein the locking mechanism is self-adjusting to changes in the closed position.

11. A dust collector comprising:
a housing having an main inlet, an main outlet, a main air filter access port sealable by a main air filter door, and mounts for a plurality of main filters;
a backdraft damper coupled to the inlet, the backdraft damper comprising:
a body having an interior volume with an inlet and an outlet configured to allow a fluid to flow therethrough; and
a flap valve having a valve seat disposed in the interior volume, the flap valve comprises:
a blade disposed in the interior volume and movable between an open position and a closed position which prevents fluid flow between the inlet and outlet of the body, the blade comprising:
a first plate;
a second plate; and
a core material sandwiched between the first and second plates.

12. The dust collector of claim 11, wherein the blade is configured to block fluid flowing from the outlet at a pressure of at least between about 0.35 bar and about 0.10 bar.

13. The dust collector of claim 11, wherein an exterior surface of the blade facing the inlet when in the closed position is without protruding elements.

14. The dust collector of claim 11 further comprising:
a shaft coupled to the blade and having a square profile.

15. The dust collector of claim 14, further comprising:
a handle attached to the square profile of the shaft; and
a latch configured to engage the handle and automatically lock movement of the blade when the blade in the closed position.

16. The dust collector of claim 14, wherein the square profile of the shaft is laminated between the plates.

17. The dust collector of claim 11, wherein the blade further comprises:
a wear liner disposed on the first plate.

18. The dust collector of claim 11 further comprising a sensor or window configured to detect a condition of the wear liner.

19. The dust collector of claim 11, wherein the first plate and the second plate are formed from aluminum, and the core material is formed from a honeycomb material.

20. The dust collector of claim 11, wherein the backdraft damper further comprises:
a locking mechanism configured to automatically retain the blade in the closed position.

21. The dust collector of claim 20, wherein the locking mechanism is self-adjusting to changes in the closed position.

22. A method of preventing a pressure wave from propagating upstream of a dust collector, comprising:
drawing air flow into a backdraft damper having a cored damper blade disposed in an open position; and
locking the cored damper blade in a closed position in response to a pressure wave propagating in a direction opposite the drawn air flow.

23. The method of claim 22, further comprising:
using a sensor or a view window to detect ware on the cored damper blade.
